(19) United States
(12) Patent Application Publication
(10) Pub. No.: US 2023/0350976 A1
(43) Pub. Date: Nov. 2, 2023

(54) SYSTEM AND METHOD FOR OPTIMIZATION USING QUANTUM HAMILTONIAN DESCENT

(71) Applicant: University of Maryland, College Park, College Park, MD (US)

(72) Inventors: Xiaodi WU, Brookline, MA (US); Jiaqi LENG, Greenbelt, MD (US); Ethan HICKMAN, Palo Alto, CA (US); Joseph LI, Olney, MD (US)

(21) Appl. No.: 18/140,760

(22) Filed: Apr. 28, 2023

Related U.S. Application Data
(60) Provisional application No. 63/363,901, filed on Apr. 29, 2022.

(51) Int. Cl. G06F 17/18

(52) U.S. Cl. CPC G06F 17/18

(57) ABSTRACT

A system for quantum optimization includes a quantum computing system, a processor, and a memory. The memory includes instructions stored thereon, which, when executed by the processor, cause the quantum computing system to: access a non-convex problem with an objective function ƒ, solve the non-convex problem using quantum Hamiltonian descent (QHD); and display results of the solved non-convex problem.

### CROSS-REFERENCE TO RELATED APPLICATION/CLAIM OF PRIORITY

This application claims the benefit of, and priority to, U.S. Provisional Patent Application No. 63/363,901, filed on Apr. 29, 2022, the entire contents of which are hereby incorporated herein by reference.

### GOVERNMENT SUPPORT

This invention was made with government support under CCF1816695 and CCF1942837 awarded by the National Science Foundation (NSF). The government has certain rights in the invention.

### TECHNICAL FIELD

The present disclosure relates generally to systems and methods for continuous optimization. More specifically, the present disclosure provides, for example, a system and method for a quantum counterpart of classical gradient descent methods for continuous optimization, referred to herein as quantum Hamiltonian descent (“QHD”).

### BACKGROUND

A conventional approach to quantum speedups in optimization relies on the quantum acceleration of intermediate steps of classical algorithms while keeping the overall algorithmic trajectory and solution quality unchanged.

Accordingly, there is interest in quantum computing for continuous optimization.

### SUMMARY

An aspect of the present disclosure provides a system for quantum optimization that includes a quantum computing system, a processor, and a memory. The memory includes instructions stored thereon, which, when executed by the processor, cause the quantum computing system to access a non-convex problem with an objective function ƒ, solve the non-convex problem using quantum Hamiltonian descent (QHD), and display results of the solved non-convex problem.

In an aspect of the present disclosure, solving the non-convex problem may include using the QHD to determine at least one of a global minimum or maximum of the non-convex problem.

In another aspect of the present disclosure, solving the non-convex problem may include using three consecutive phases, including a kinetic phase, a global search phase, and a descent phase.

In an aspect of the present disclosure, the QHD may include time-dependent parameters configured to enable convergence to a global minimum, regardless of a shape of ƒ.

In another aspect of the present disclosure, a quantum state of the quantum computing system in QHD may remain in a low-energy subspace [symbol] in a quantum evolution, and the low-energy subspace [symbol] may settle at the global minimizer of ƒ.

In an aspect of the present disclosure, in the global search phase, kinetic energy in the system may start to drain out. A wave function may show a selectivity toward the global minimum of ƒ. In a probability spectrum, a high-energy cluster in the wave function may be driven toward the low-energy subspace [symbol] .

In another aspect of the present disclosure, the quantum computing system may be configured to locate a global minimum of ƒ after the screening of the entire search domain in the kinetic phase.

In an aspect of the present disclosure, in the descent phase, the wave function may settle and become concentrated near the global minimizer of ƒ. The wave function may remain in a low-energy subspace [symbol] .

In another aspect of the present disclosure, a quantum evolution may converge to the global minimizer x*.

In an aspect of the present disclosure, solving the non-convex problem using the QHD may include: embedding a Hamiltonian equation of the non-convex problem in the quantum computing system by: discretizing the Hamiltonian equation to a finite-dimensional matrix; identifying an invariant subspace [symbol] of the simulator Hamiltonian for an evolution; programming the simulator Hamiltonian, where a restriction to the invariant subspace [symbol] matches the discretized Hamiltonian; evolving the simulator Hamiltonian for a period of time for the evolution to pass through a kinetic phase and a global search phase, and into a descent phase; and measuring the subspace [symbol] to generate solutions to an optimization problem based on the simulator Hamiltonian.

In another aspect of the present disclosure, a convergence to a global optimum may be established in both a convex and a non-convex setting.

In an aspect of the present disclosure, QHD may include a continuous-time Hamiltonian evolution.

In another aspect of the present disclosure, the system may further include a quantum simulator including a Quantum Ising Machine.

In another aspect of the present disclosure, by embedding the dynamics of QHD into the evolution of a Quantum Ising Machine (QIM) in a quantum computing system, the embedded QHD outperforms a selection of state-of-the-art gradient-based classical solvers and the standard quantum adiabatic algorithm, based on the time-to-solution metric, on non-convex constrained quadratic programming instances up to 75 dimensions.

An aspect of the present disclosure provides a processor-implemented method for quantum optimization, including: accessing a non-convex problem with an objective function ƒ, solving the non-convex problem using quantum Hamiltonian descent (QHD) by determining at least one of a global minimum or maximum of the non-convex problem; and displaying results of the solved non-convex problem.

In another aspect of the present disclosure, solving the non-convex problem may include using three consecutive phases including a kinetic phase, a global search phase, and a descent phase.

In an aspect of the present disclosure, the QHD may include time-dependent parameters configured to enable convergence to a global minimum, regardless of a shape of ƒ.

In another aspect of the present disclosure, the method may further include embedding the QHD Hamiltonian in an analog quantum simulator.

An aspect of the present disclosure provides a non-transitory computer-readable storage medium storing a program for causing a processor to execute a method of quantum optimization. The method includes: accessing a non-convex problem with an objective function ƒ, solving the non-convex problem using quantum Hamiltonian descent (QHD) by: determining at least one of a global minimum or maximum of the non-convex problem; and displaying results of the solved non-convex problem.

Further details and aspects of exemplary aspects of the present disclosure are described in more detail below with reference to the appended figures.

### BRIEF DESCRIPTION OF THE DRAWINGS

A better understanding of the features and advantages of the present disclosure will be obtained by reference to the following detailed description that sets forth illustrative aspects, in which the principles of the present disclosure are utilized, and the accompanying drawings of which:

FIG. 1 is a diagram of an exemplary system for optimization using quantum Hamiltonian descent (QHD), in accordance with examples of the present disclosure;

FIG. 2A is a diagram illustrating a classical gradient method being trapped in a local minimum, in accordance with examples of the present disclosure;

FIG. 2B is a diagram illustrating that the QHD method of FIG. 1 can easily escape and find near optimal solutions, in accordance with examples of the present disclosure;

FIG. 3 is a diagram of surface and heatmap plots of a Levy function, in accordance with examples of the present disclosure;

FIG. 4 are graphs illustrating success probabilities of QHD in comparison to three optimization algorithms, in accordance with examples of the present disclosure;

FIG. 5 is a diagram of a method for deriving QHD, in accordance with examples of the present disclosure;

FIG. 6 is a diagram illustrating the three phases of QHD, in accordance with examples of the present disclosure;

FIG. 7 is a set of graphs illustrating surface plots of the probability density in QHD at different evolution times for the Levy function, in accordance with examples of the present disclosure;

FIG. 8 is a graph illustrating a probability spectrum of QHD over a period of time, in accordance with examples of the present disclosure;

FIG. 9 is a graph illustrating a success probability of QHD over a period of time, in accordance with examples of the present disclosure;

FIG. 10 is a graph illustrating an energy ratio E₁/E₀ in QHD shown as a function of time t, in accordance with examples of the present disclosure; and

FIGS. 11-14 illustrate box plots of the time-to-solution (TTS) of selected quantum and classical solvers, in 5, 50, 60, and 75 dimensions, respectively, in accordance with examples of the present disclosure; and

FIG. 15 is a diagram of a method for QHD for the quantum computing system of FIG. 1, in accordance with examples of the present disclosure.

### DETAILED DESCRIPTION

The present disclosure relates generally to a system and method for continuous optimization. More specifically, the present disclosure provides at least a system and method for a quantum counterpart of classical gradient descent methods for continuous optimization, referred to herein as quantum Hamiltonian descent (“QHD”).

Aspects of the present disclosure are described in detail with reference to the drawings wherein like reference numerals identify similar or identical elements.

Although the present disclosure will be described in terms of specific examples, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary aspects illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

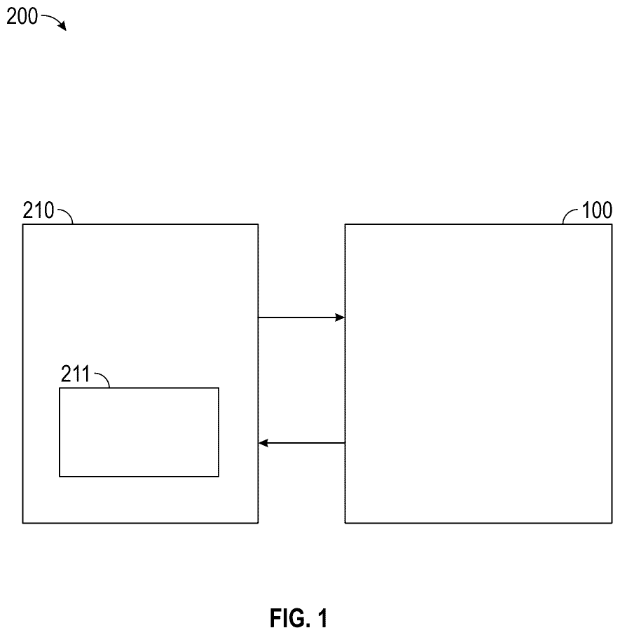

Referring to FIG. 1, a diagram of an exemplary system 200 for optimization using quantum Hamiltonian descent (QHD), in accordance with the present disclosure, is shown.

QHD is derived from the path integral of dynamical systems referring to the continuous-time limit of classical gradient descent algorithms as a truly quantum counterpart of classical gradient methods where the contribution from classically-prohibited trajectories can significantly boost QHD's performance for non-convex optimization. Moreover, QHD is described as a Hamiltonian evolution that is efficiently simulated on both digital and analog quantum computers. By embedding the dynamics of QHD into the evolution of a Quantum Ising Machine (QIM) in a quantum computing system (e.g., D-Wave®), the embedded QHD outperforms a selection of state-of-the-art gradient-based classical solvers and the standard quantum adiabatic algorithm, based on the time-to-solution metric, on non-convex constrained quadratic programming instances up to 75 dimensions.

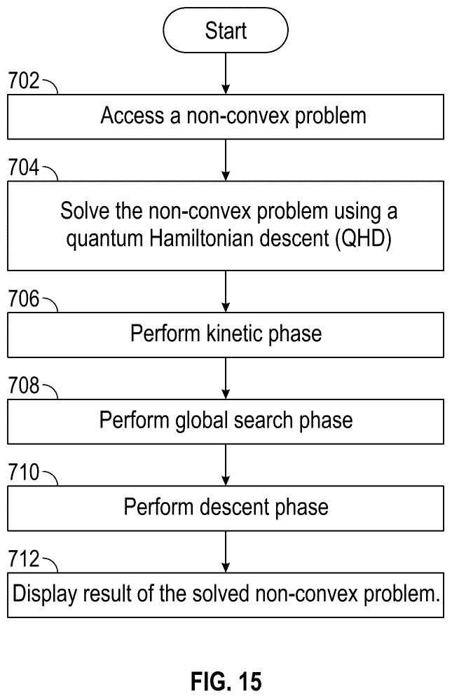

The system 200 for optimization using QHD may include a quantum computing system 100, a processor 210, and a memory 211, including instructions stored thereon, which, when executed by the processor 210, cause the quantum computing system 100 to perform the steps of method 700 of FIG. 15.

The processor 210 may be connected to a computer-readable storage medium or a memory 211. The computer-readable storage medium or memory 211 may be a volatile type of memory, e.g., RAM, or a non-volatile type of memory, e.g., flash media, disk media, etc. In various aspects of the disclosure, the processor 210 may be any type of processor such as a quantum processor, a digital signal processor, a microprocessor, an ASIC, a graphics processing unit (GPU), a field-programmable gate array (FPGA), or a central processing unit (CPU).

In aspects of the disclosure, the memory 211 can be a quantum memory, random access memory, read-only memory, magnetic disk memory, solid-state memory, optical disc memory, and/or another type of memory. In some aspects of the disclosure, the memory 211 can be separate from the processor and can communicate with the processor through communication buses of a circuit board and/or through communication cables such as serial ATA cables or other types of cables. The memory 211 includes computer-readable instructions that are executable by the processor 210 to operate the processor. In other aspects of the disclosure, the system 200 may include a network interface to communicate with other computers or to a server. A storage device may be used for storing data.

Gradient descent (and its variant) is an optimization algorithm used in continuous optimization due to its simplicity and efficiency in converging to critical points. However, many real-world problems have spurious local optima, for which gradient descent is subject to slow convergence since it only leverages first-order information.

On the other hand, quantum algorithms have the potential to escape from local minima and find near-optimal solutions by leveraging the quantum tunneling effect. Therefore, it is desirable to identify a quantum counterpart of gradient descent that is simple and efficient on quantum computers while leveraging the quantum tunneling effect to escape from spurious local optima. With such features, the quality of the solutions is improved. Prior attempts to quantize gradient descent, which followed the conventional approach, unfortunately, fail to achieve the aforementioned goal, which seems to require a completely new approach to quantization.

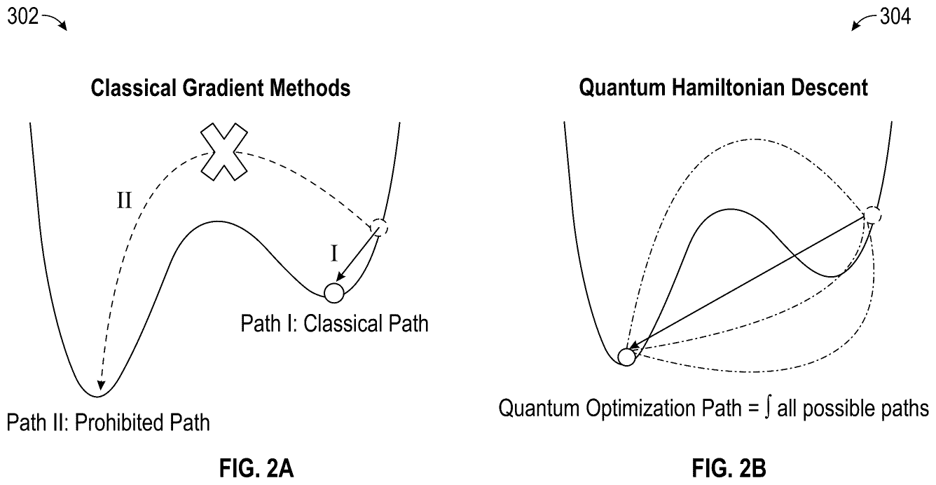

FIG. 2A and FIG. 2B are illustrative examples where classical gradient descent with bad initialization will be trapped in a local minimum, while QHD can easily escape and find near-optimal solutions by taking the path integral of trajectories prohibited by classical mechanics. FIG. 2A and FIG. 2B illustrate a conceptual picture of QHD's quantum speedup: intuitively, QHD is a path integral of solution trajectories, some of which are prohibited in classical gradient descent. Interference among all solution trajectories gives rise to a unique quantum phenomenon called quantum tunneling, which helps QHD overcome high-energy barriers and locate the global minimum.

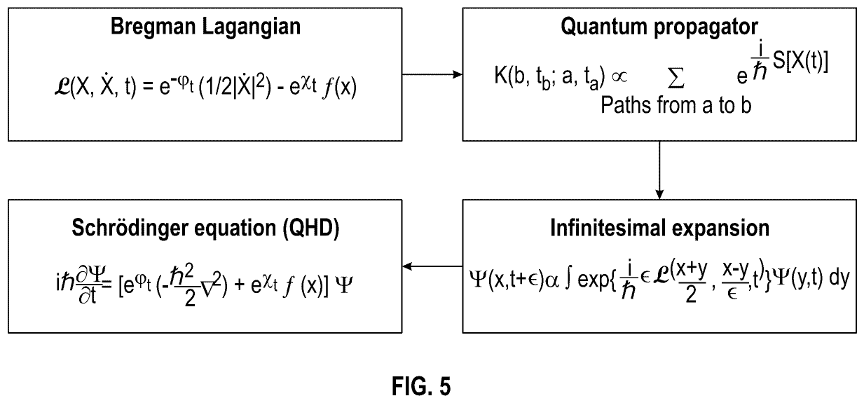

There exists an unintuitive connection between gradient descent and dynamical systems satisfying classical physical laws. The system quantizes the continuous-time limit of gradient descent as a whole, and the resulting quantum dynamical systems lead to quantum algorithms as seen in FIG. 5. Using the path integral formulation of quantum mechanics in FIG. 5, the Bregman-Lagrangian framework is quantized to obtain a quantum-mechanical system governed by the Schrödinger equation

$$i \frac{d}{dt} Ψ ( t ) = \hat{H} ( t ) Ψ ( t ) ,$$

where Ψ(t) is the quantum wave function, and the quantum Hamiltonian reads:

$$\hat{H} ( t ) = {e}^{{φ}_{t}} ( - \frac{1}{2} Δ ) + {e}^{Xt} f ( x ) \qquad ( Eqn . 1 )$$

where e^{φt}, e^{χt} are damping parameters that control the energy flow in the system. The system sets e^{φt/χt}→0 for large t so the kinetic energy is gradually drained out from the system, which is crucial for the long-term convergence of the evolution. Just like the Bregman-Lagrangian framework, different damping parameters in Ĥ(t) correspond to different prototype gradient-based algorithms. Δ is the Laplacian operator over Euclidean space. ƒ(x), the objective function to minimize, is assumed to be unconstrained and continuously differentiable. The Schrödinger dynamics in Eqn. 1 generates a family of quantum gradient descent algorithms (QHD).

QHD takes in an initial wave function Ψ(0) and evolves the quantum computing system. The solution to the optimization problem is obtained by measuring the position observable \hat{x} at the end of the algorithm (i.e., at time t=T).

For convex problems, QHD is guaranteed to find a global solution. In this case, the solution trajectory of QHD is analogous to that of a classical algorithm. Non-convex problems, known to be NP-hard in general, are much harder to solve. Under mild assumptions on a non-convex ƒ, the global convergence of QHD is given appropriate damping parameters and a sufficiently long evolution time.

To highlight the efficiencies of QHD, examples using four different algorithms are presented. The examples herein are intended for demonstration only and are not intended to be limiting. The four test algorithms include QHD; Quantum Adiabatic Algorithm (QAA); Nesterov's accelerated gradient descent (NAGD); and stochastic gradient descent (SGD)). These tests are conducted via classical simulation on 22 optimization instances with diversified landscape features selected from benchmark functions for global optimization problems.

QAA solves an optimization problem by simulating a quantum adiabatic evolution, and it has mostly been applied to discrete optimization in the literature. To solve continuous optimization with QAA, a common approach is to represent each continuous variable with a finite-length bitstring so the original problem is converted to combinatorial optimization defined on the hypercube {0,1}^{N}, where N is the total number of bits (e.g.,). The test adopts the radix-2 representation (i.e., binary expansion) and assigns 7 bits for each continuous variable to allow QAA to handle the optimization instances as discrete problems over {0,1}¹⁴.

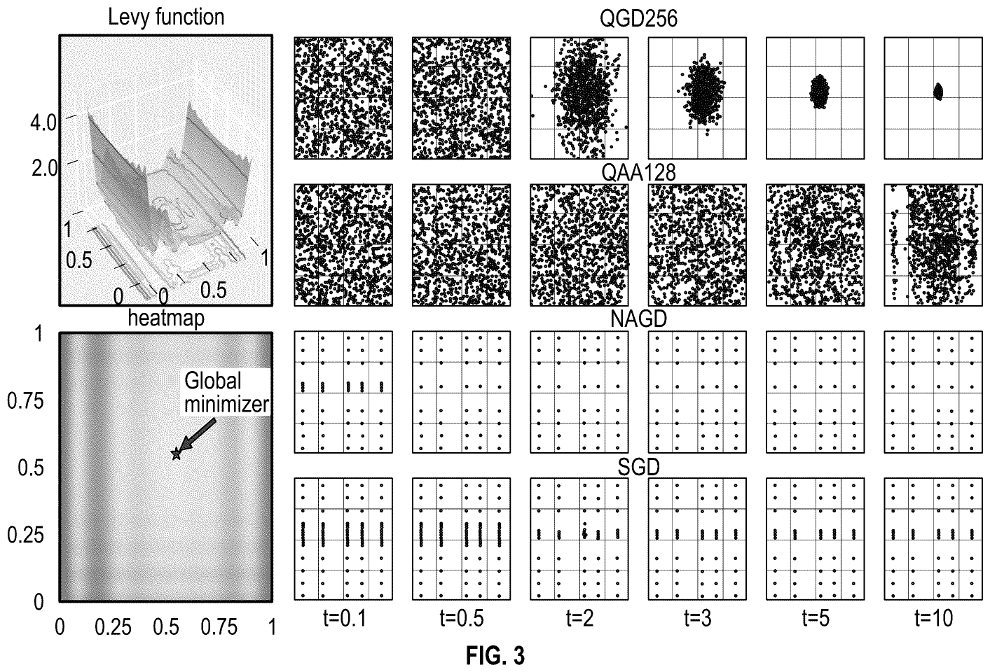

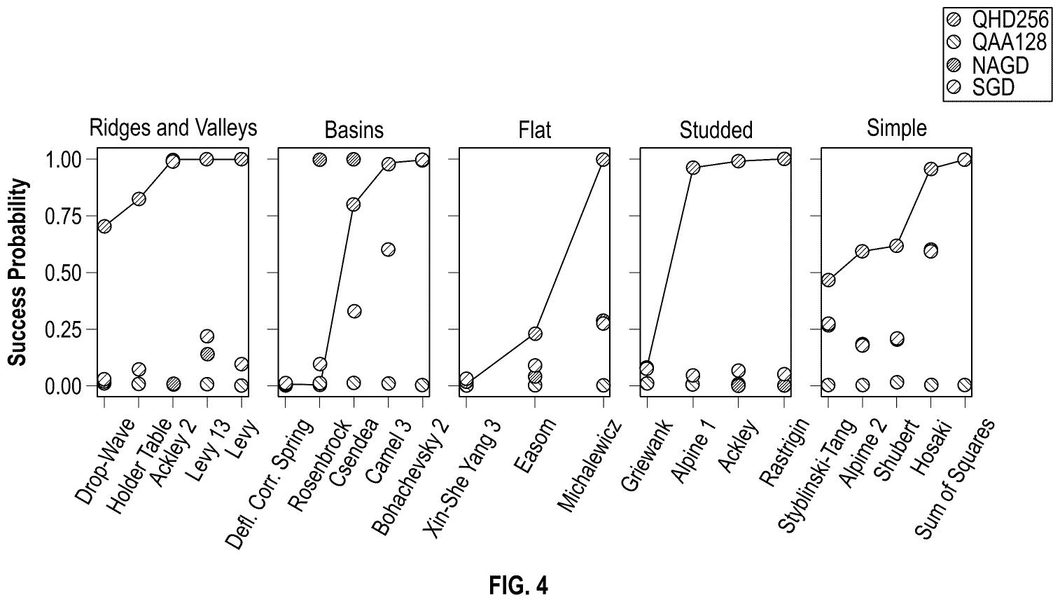

With reference to FIG. 3, the test results are demonstrated by a surface and heatmap plot. Samples from the distributions of QHD, QAA, NAGD, and SGD at different (effective) evolution times t=0.1,0.5,2,3,5,10 are shown as scatter plots. The final success probabilities of QHD, QAA, NAGD, and SGD for all 22 instances. A final solution xₖ is considered “successful” if |xₖ−x*|<0.1, where x* is the (unique) global minimizer of ƒ. Data are categorized into five groups by landscape features of the objective functions.

As demonstrated in FIG. 3, the plot shows the landscape of Levy function, and the solutions from the four algorithms are shown for different evolution times t. For QHD and QAA, t is the evolution time of the quantum dynamics; for the two classical algorithms, the effective evolution time t is computed by multiplying the step size and the number of iterations so that it is comparable to the one used in QHD and QAA. Compared with QHD, QAA converges at a much slower speed, and little apparent convergence is observed within the time window. Although the two classical algorithms seem to converge faster than quantum algorithms, they have a lower success probability because many solutions are trapped in spurious local minima. The use of the Levy function in FIG. 3 is consistent with the results of other functions: QHD has a higher success probability in most optimization instances at the same choice of total effective evolution time. QHD provides the benefit of leveraging the quantum tunneling effect to escape from spurious local minima.

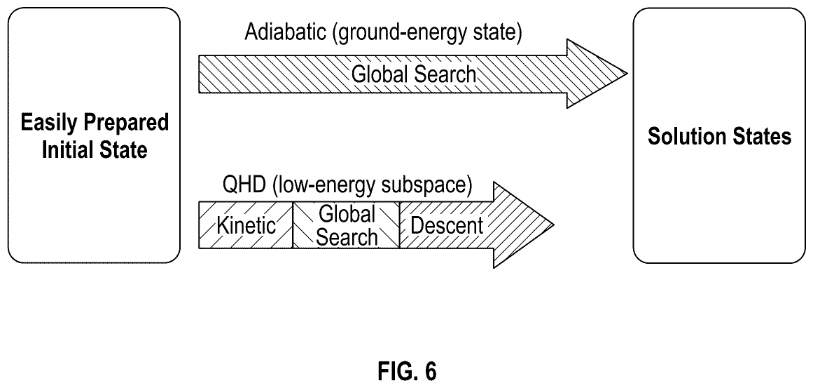

As seen in FIG. 6, a diagram of the three phases of QHD is shown. QHD solves optimization problems using three consecutive phases called the kinetic phase 606, the global search phase 608, and the descent phase 610. The three stages enable QHD to have faster convergence for continuous problems. QHD includes time-dependent parameters such that the convergence to the global minimum is guaranteed, regardless of the shape of ƒ. This is because the quantum state of the quantum computing system in QHD stays in the low-energy subspace in the evolution, and the low-energy subspace will eventually settle at the global minimizer of ƒ.

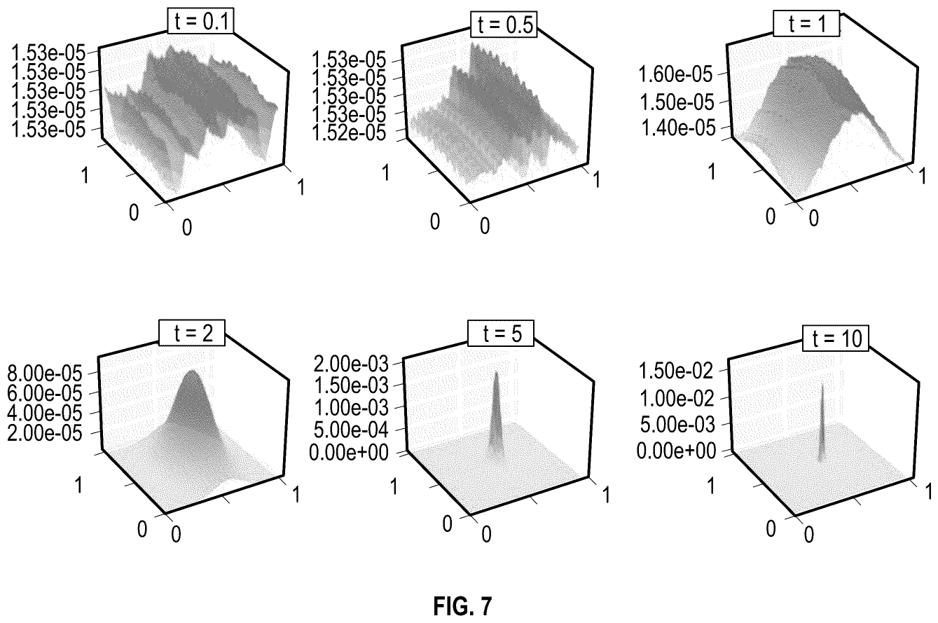

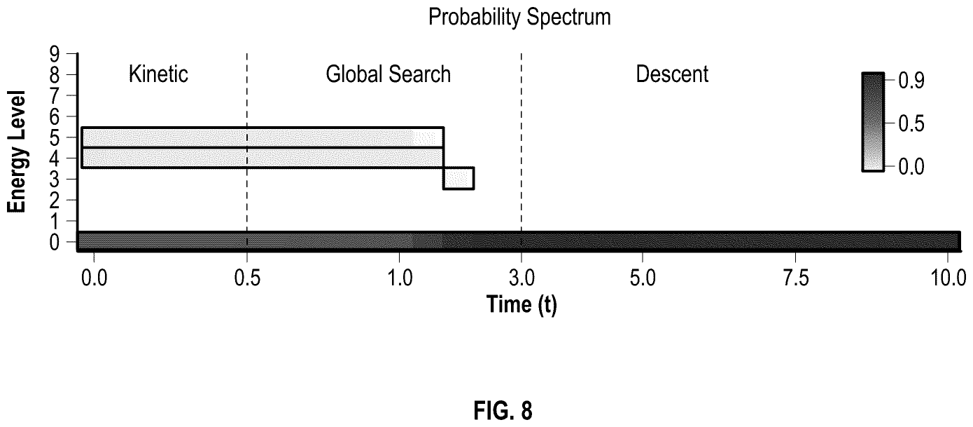

In the kinetic phase 606 of QHD, the wave function is of ample kinetic energy, and it rapidly bounces within the whole search space (see t=0:1; 0:5 in FIG. 7). While the majority of the probability spectrum is in the low-energy subspace, a mid- or high-energy cluster in the probability spectrum prevails. The two energy clusters co-exist and almost do not interact. This phase is called the kinetic phase of QHD because it is characterized by the mobility of wave functions (as a result of the dominating kinetic energy term).

In the global search phase 608 of QHD, the kinetic energy in the system starts to drain out. The wave function becomes less oscillatory and shows a selectivity toward the global minimum of ƒ(see t=1; 2 in FIG. 7). In the probability spectrum, the high-energy cluster in the wave function is driven toward the low-energy subspace, and this trend does not reverse. This phase is called the global search phase because the quantum computing system manages to locate the global minimum of ƒ after the screening of the whole search domain in the kinetic phase 606. This phase further separates QHD from other classical gradient methods.

In the descent phase 610 of QHD, the wave function settles and becomes increasingly concentrated near the global minimizer of ƒ (see t=5; 10 in FIG. 7). The wave function stays in the low-energy subspace. In this phase, the quantum evolution enters the semi-classical regime in which the potential energy term dominates. QHD starts to behave like classical gradient descent as it converges to the global minimizer x*.

QHD is closed under time dilation, i.e., time-dilated QHD evolution is also described by the QHD equation but with different time-dependent parameters. This means the continuous-time QHD can converge at any speed along the same evolution path. The quantum evolution Ψ(x,t) for t∈[0, T] forms a curve in the Hilbert space L²(R^{d}).

FIG. 7 demonstrates surface plots of the probability density in QHD at different evolution times for the Levy function. The QHD dynamics illustrate rich dynamical properties at different stages of evolution. First, the initial wave function becomes highly oscillatory and spreads to the full search space (t=0.1,0.5). Then, the wave function sees the landscape of ƒ and starts moving towards the global minimum (t=1,2). Finally, the wave packet is clustered around the global minimum and converges like a classical gradient descent (t=5,10). This three-stage evolution is not only seen in the Levy function but also observed in many others.

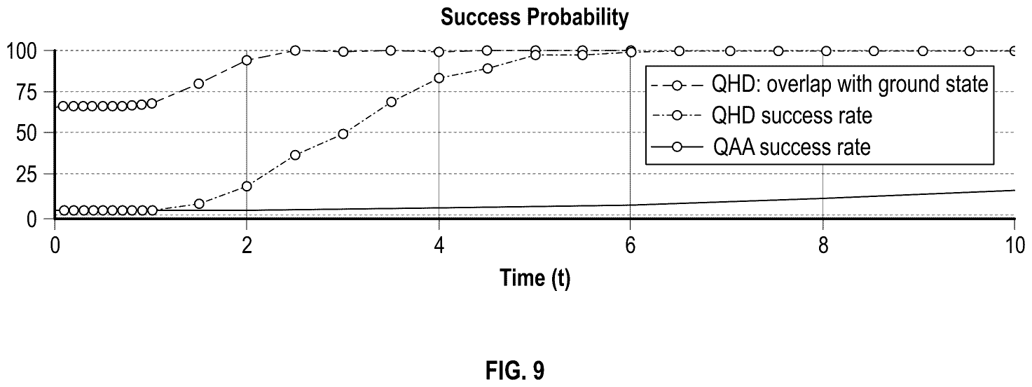

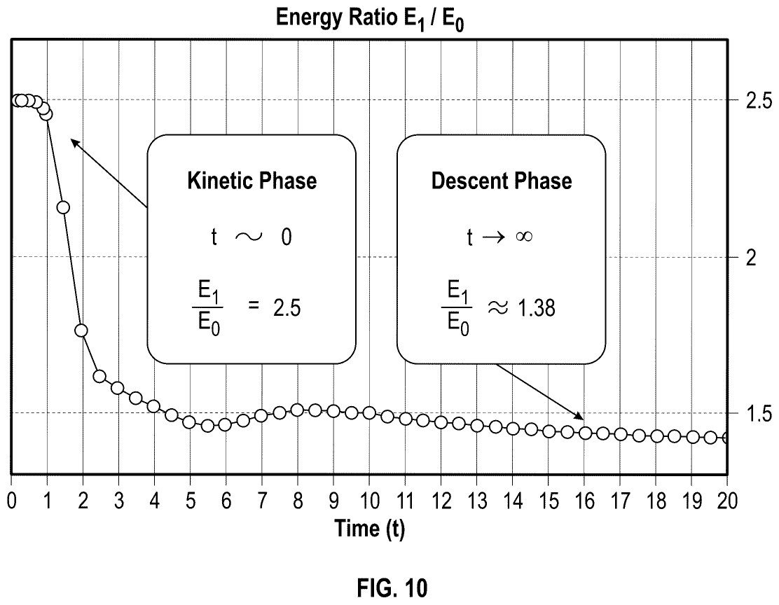

The three-phase picture of QHD may be supported by several quantitative characterizations of the QHD evolution. One such characterization is the probability spectrum of QHD, which shows the decomposition of the wave function to different energy levels. QHD begins with a major ground-energy component and a minor low-energy component. During the global search phase, the low-energy component is absorbed into the ground-energy component, indicating that QHD finds the global minimum (FIG. 9). The energy ratio E₁/E₀ is another characterization of the three phases in QHD (FIG. 10), where E₀(or E₁) is the ground (or first excited) energy of the QHD Hamiltonian Ĥ(t). In the kinetic phase, the kinetic energy

$$- \frac{1}{2} Δ$$

dominates in the system Hamiltonian, hence E₁/E₀≈2.5, which is the same as in a free-particle system. In the descent phase, the QHD Hamiltonian enters the “semi-classical regime,” and the energy ratio can be computed based on the objective function.

The three-phase picture of QHD sheds light on why QAA has slower convergence. Compared to QHD, QAA has neither a kinetic phase nor a descent phase. In the kinetic phase, QHD averages the initial wave function over the whole search space to reduce the risk of poor initialization, while QAA remains in the ground state throughout its evolution, so it never gains as much kinetic energy. In the descent phase, QHD exhibits convergence similar to classical gradient descent and is insensitive to spatial resolution; such fast convergence is not seen in QAA.

In QAA, the use of the radix-2 representation scrambles the Euclidean topology so that the resulting discrete problem is even harder than the original problem. Failing to incorporate the continuity structure, QAA is sensitive to the resolution of spatial discretization, and higher resolutions often cause worse QAA performance.

QHD can solve high-dimensional non-convex problems, with the great advantage of continuous-time analog quantum devices for quantum simulation in the NISQ era due to their scalability and lower overhead for simulation tasks. A unique feature of QHD is that its description is itself a Hamiltonian simulation task, which makes it possible to leverage near-term analog quantum devices for its implementation.

For example, an analog implementation of QHD would be building a quantum simulator whose Hamiltonian exactly matches the target QHD Hamiltonian (eqn. 1). As another example, the QHD Hamiltonian may be embedded into existing analog simulators to emulate QHD as part of the full dynamics. Other implementations of QHD are likewise contemplated.

The Quantum Ising Machine (QIM) embodies an n-qubit quantum register which permits 1) initialization, i.e., the quantum register is initialized to a certain quantum state; 2) the evolution of the quantum register is described by a Schrödinger equation; and 3) the quantum register is measured in the computational basis.

When the QHD Hamiltonian is embedded into analog quantum simulators, a QIM is presented as a model for powerful analog quantum simulators described by the following quantum Ising Hamiltonian:

$$H ( t ) = - \frac{A ( t )}{2} ( {Σ}_{j} {σ}_{x}^{( j )} ) + \frac{B ( t )}{2} ( {Σ}_{j} {h}_{j} {σ}_{z}^{( j )} + {Σ}_{j > k} {J}_{j , k} {σ}_{z}^{( j )} {σ}_{z}^{( k )} ) \qquad ( Eqn . 2 )$$

where σₓ^{(j)} and σ_{z}^{(j)} are the Pauli-X and Pauli-Z operators acting on the j-th qubit, A(t) and B(t) are time-dependent control functions. The controllability of A(t), B(t), hⱼ, J_{j,k} represents the programmability of QIMs, which depend on the specific instantiation of QIM such as the D-Wave systems, QuEra neutral-atom system, or otherwise.

At a high level, the Hamiltonian embedding technique comprises the following steps: (i) discretizing the QHD Hamiltonian (Eqn. 1) to a finite-dimensional matrix; (ii) identifying an invariant subspace S of the simulator Hamiltonian for the evolution; and (iii) programming the simulator Hamiltonian (Eqn. 2) so its restriction to the invariant subspace S matches the discretized QHD Hamiltonian. These steps, among others, simulate the QHD Hamiltonian in the subspace S (called the encoding subspace) of the simulator's full Hilbert space. When measuring the encoding subspace at the end of the analog emulation, solutions to an optimization problem are found.

As an example, in the one-dimensional case of QHD Hamiltonian, where

$$\hat{H} ( t ) = {e}^{{φ}_{t}} ( - \frac{1}{2} \frac{{\partial }^{2}}{\partial {x}^{2}} ) + {e}^{{χ}_{t}} f ,$$

a standard discretization by the finite difference method, QHD Hamiltonian becomes

$$\hat{H} ( t ) = - \frac{1}{2} {e}^{{φ}_{t}} \hat{L} + {e}^{{χ}_{t}} \hat{F}$$

where the second-order derivative

$$\frac{{\partial }^{2}}{\partial {x}^{2}}$$

becomes a tridiagonal matrix (denoted by \hat{L}), and the potential operator ƒ is reduced to a diagonal matrix (denoted by \hat{F}).

The Hamming encoding subspace S_{H} which is spanned by (n+1) Hamming states {|Hⱼ [symbol] : j=0, 1, . . . , n} for any n-qubit QIM. By choosing appropriate parameters hⱼ, J_{j,k} in (Eqn. 2), the subspace [symbol] _{H} is invariant under the QIM Hamiltonian.

Moreover, the restriction of the first term Σⱼ₌₁^{r}σₓ^{j} onto [symbol] _{H} resembles the tridiagonal matrix \hat{L}, and the restriction of the second term in the QIM Hamiltonian (with Pauli-Z and -ZZ operators) represents a discretized quadratic function \hat{F}. A measurement on [symbol] _{H} may be conducted by measuring the full simulator Hilbert space in the computational basis and simple post-processing. The Hamming encoding construction is readily generalizable to higher-dimensional Laplacian operator Δ and quadratic polynomial functions ƒ.

The Hamming encoding enables an empirical study of an interesting optimization problem called quadratic programming (QP) on quantum simulators. Specifically, QP with box constraints:

$$\begin{matrix}minimize & f ( x ) = \frac{1}{2} {x}^{T} Qx + {b}^{T} x , \\ subject to & 0 ≼ x ≼ 1 ,\end{matrix}$$

where 0 and 1 are n-dimensional vectors of all zeros and all ones, respectively. Non-convex QP problems (i.e., ones in which the Hessian matrix Q is indefinite) are known to be NP-hard in general.

QHD is a quantum algorithm for continuous optimization in both convex and non-convex settings. It is derived from the path integral formulation of quantum mechanics and is a quantum counterpart to classical gradient-based optimization methods. To carry out QHD on an optimization problem using an actual quantum device, the Schrödinger equation for a finite amount of time must be solved. This task is called Hamiltonian simulation because a Schrödinger equation is fully described by a Hamiltonian operator. In principle, the Hamiltonian simulation of QHD can be done on a gate-based quantum computer, but for optimization problems of interest, a QHD program may require many billions of consecutive gates, well beyond any near-term expectations of gate-based devices.

Thus, analog quantum computing is turned to. Analog quantum computers solve problems by emulating a quantum system, and the solution is read out by measuring the final state of the analog quantum computer. Like any other quantum system, an analog quantum computer is described by its own system Hamiltonian, which is referred to as its machine Hamiltonian. We can solve certain problems on an analog quantum computer by programming its machine Hamiltonian.

The Hamming encoding, may enable QIMs to solve continuous optimization problems with quadratic objective functions and box constraints (i.e., quadratic programming with box constraints) via QHD. The D-Wave® machine is used in the experiments as a QIM, albeit with some restrictions on its behavior (apart from the behavior of an idealized QIM). One key feature of the D-Wave® device that was used is that over its evolution it transitions from a simple initial Hamiltonian to a user-programmed Ising Hamiltonian. By using the Hamming encoding of states, the initial Hamiltonian of the QIM is made equivalent to the kinetic energy operator in QHD. Then, over the course of the evolution of the QIM, from a full weighting on the initial Hamiltonian term to a full weighting on the programmed Hamiltonian term, the QIM has actually carried out QHD, by starting with a full weighting on the encoded kinetic term and finishing with a full weighting on the encoded problem Hamiltonian term that was programmed. Measurement at the end of the evolution gives encoded solutions to the optimization problem, which are decoded into solutions to the original problem.

The disclosed embedding technique enables the behavior of the D-Wave® machine (hereinafter referred to as DW-QHD) to mimic the behavior of QHD and allows for the control of thousands of physical qubits with decent connectivity. The D-Wave® machine is used as an example. However, other quantum computing systems are contemplated to be within the scope of the disclosure.

As an example, DW-QHD is compared with 6 other systems: DW-QAA (baseline QAA implemented on D-Wave®), IPOPT, SNOPT, MATLAB's fmincon algorithm (with SQP solver), QCQP, and a basic SciPy minimize function (with TNC solver).

In the two quantum methods (DW-QHD, DW-QAA), the search space [0,1]^{d} is discretized into a regular mesh grid with 8 cells per edge due to the limited number of qubits in the D-Wave® machine. To compensate for the loss of resolution, the post-process coarse-grained D-Wave® results by the SciPy minimize function, which is a local gradient solver mimicking the descent phase of a higher-resolution QHD and only has a mediocre performance by itself. The choice of classical solvers covers a variety of existing optimization methods, including gradient-based local search (SciPy minimize), interior-point method (IPOPT), sequential quadratic programming (SNOPT, MATLAB), and heuristic convex relaxation (QCQP). Finally, to investigate the quality of the D-Wave® machine in implementing QHD and QAA, QHD and QAA are simulated for the 5-dimensional instances (Sim-QHD, Sim-QAA).

The time-to-solution (TTS) metric compares the performance of solvers. TTS is the number of trials (i.e., initializations for classical solvers or shots for quantum solvers) required to obtain the correct global solution up to 0.99 success probability:

$$TTS = {t}_{f} \times ⌈ \frac{ln ( 1 - 0.99 )}{ln ( 1 - {p}_{s} )} ⌉ \qquad ( Eqn . 3 )$$

where t_{ƒ} is the average runtime per trial, and pₛ is the success probability, i.e., the probability of finding the global solution in a given trial. 1000 trials per instance were executed, and the TTS was computed for each solver.

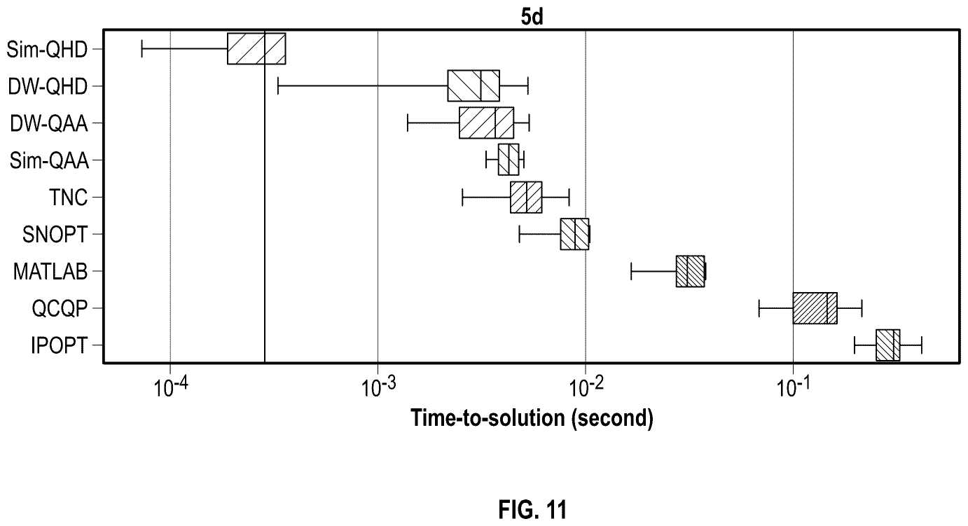

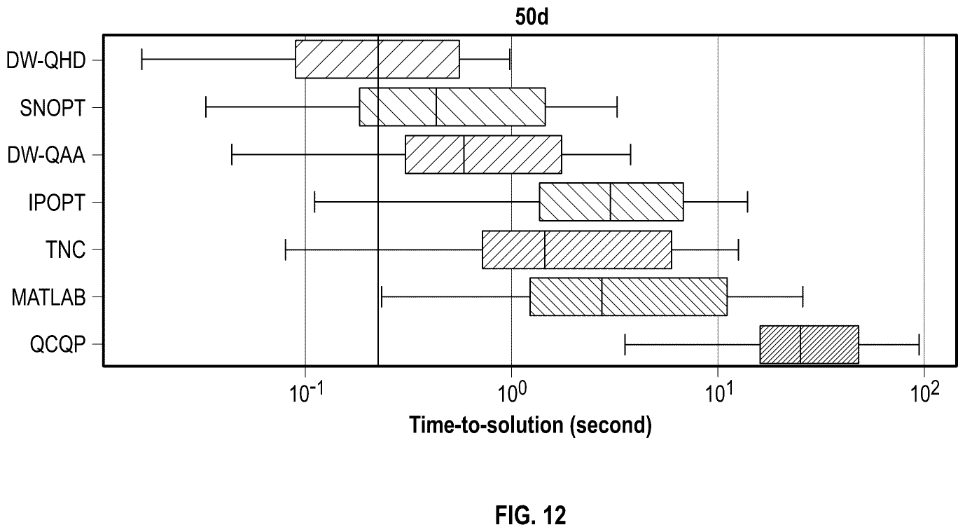

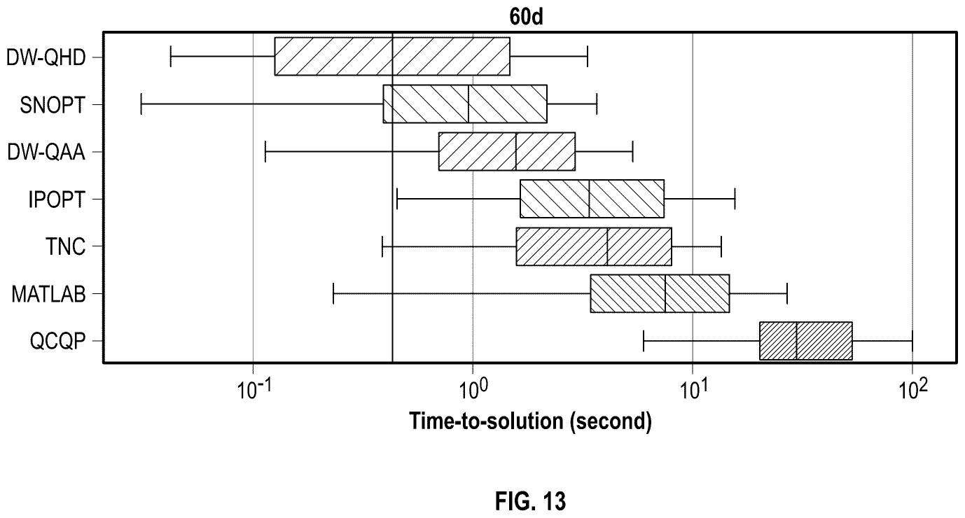

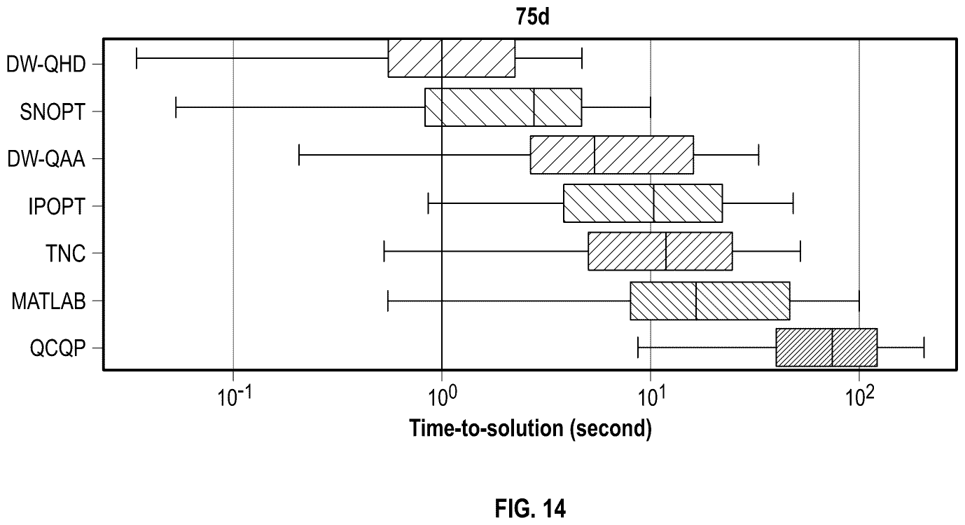

FIGS. 11-14 illustrate box plots of the time-to-solution (TTS) of selected quantum and classical solvers, gathered from four randomly generated quadratic programming benchmarks in 5, 50, 60, and 75 dimensions, respectively. The left and right boundaries of a box show the lower and upper quartiles of the TTS data, while the whiskers extend to show the rest of the TTS distribution. The median of the TTS distribution is shown as a black vertical line in the box. In each panel, the median line of the best solver extends to show the comparison with all other solvers. In the 5-dimensional case, Sim-QHD has the lowest TTS, and the quantum methods are generally more efficient than classical solvers. Note that with a much shorter annealing time (t_{ƒ}=1 μs for Sim-QHD and t_{ƒ}=800 μs for DW-QHD) Sim-QHD still does better than DW-QHD, indicating the D-Wave® system is subject to significant noise and decoherence. Interestingly, Sim-QAA (t_{ƒ}=1 μs) is worse than DW-QAA (t_{ƒ}=800 μs), which shows QAA indeed has much slower convergence. In the higher dimensional cases, DW-QHD has the lowest median TTS among all tested solvers. FIG. 11 demonstrates that the 5-dimensional case suggests that an implementation of QHD performs much better than DW-QHD, and therefore all other tested solvers in high dimensions.

Referring to FIG. 15, a processor-implemented method 700 for quantum optimization, using the quantum computing system 200 of FIG. 1 is shown. The system 200 for quantum optimization, may include a processor and a memory, including instructions stored thereon, which, when executed by the processor 210, cause the quantum computing system 200 to perform the steps of method 700.

Initially, at step 702, the processor 210 causes the quantum computing system 200 to access a non-convex problem (e.g., a non-convex problem) with an objective function ƒ. Next, at step 704, the processor 210 causes the quantum computing system 200 to solve the non-convex problem using QHD. In aspects, solving the non-convex problem includes using three consecutive phases, including a kinetic phase, a global search phase, and a descent phase. In aspects, solving the non-convex problem may include using the QHD to determine a global minimum and/or maximum of the non-convex problem. The QHD may include time-dependent parameters configured to enable convergence to a global minimum, regardless of a shape of ƒ.

In aspects, QHD takes in an initial wave function Ψ(0) and evolves the quantum computing system. The solution to the optimization problem is obtained by measuring the position observable z at the end of the algorithm (i.e., at time t=T).

Next, at step 706, the processor 210 causes the quantum computing system 200 to perform the kinetic phase 606. The wave function Ψ(0) is characterized by a mobility of wave functions as a result of a dominating kinetic energy term.

Next, at step 708, the processor 210 causes the quantum computing system 200 to perform the global search phase 608. In the global search phase, kinetic energy in the system starts to drain out. The wave function Ψ(0) shows a selectivity toward the global minimum of ƒ. In a probability, spectrum a high-energy cluster in the wave function Ψ(0) is driven toward a low-energy subspace [symbol] . In aspects, the quantum computing system 200 locates a global minimum of ƒ after the screening of the entire search domain in the kinetic phase.

Next, at step 710, the processor 210 causes the quantum computing system 200 to perform the descent phase 610. In the descent phase, the wave function Ψ(0) settles and becomes concentrated near the global minimizer of ƒ, and wherein the wave function Ψ(0) remains in the low-energy subspace [symbol] . In aspects, the quantum evolution converges to the global minimizer x*.

Next, at step 712, the processor 210 displays the results of the solved non-convex problem. The results may be displayed on a display.

For example, QHD may be used to optimize power systems, analyze chemical reactions, and/or train machine learning networks (e.g., neural networks).

In aspects, a quantum walk may be embedded on a QIM. Suppose H E Herm(H) be the target Hamiltonian to be simulated. Let [symbol] ′ be the Hilbert space associated with the analog quantum simulator. The native quantum emulation of the analog quantum simulator is described by the simulator Hamiltonian [symbol] ′∈Herm( [symbol] ′).

An isometry from [symbol] to a subspace [symbol] of the simulator Hilbert space [symbol] ′: V: [symbol] → [symbol] ⊂ [symbol] ′ is considered. Denote [symbol] =VV^{†} to be the projection onto the subspace [symbol] , and [symbol] ^{⊥}= [symbol] −P [symbol] be the projection onto [symbol] ^{⊥}, the simulator Hamiltonian H′ can be represented in the following block-matrix form:

$${H}^{′} = [ \begin{matrix}{B}_{0} & R \\ {R}^{†} & {B}_{1}\end{matrix} ] ,$$

in which:

$${B}_{0} = {H}^{{′P}_{𝒮}} , R = {H}^{{′P}_{𝒮} ⊥} , {R}^{†} = ⊥ {H}^{{′P}_{𝒮}} , {B}_{1} = ⊥ {H}^{{′P}_{𝒮 ⊥}} .$$

Hamiltonian embedding: Let [symbol] be a subspace of [symbol] ′. An isometry V: [symbol] → [symbol] ⊂ [symbol] ′ gives an embedding of the target Hamiltonian H into H′ if [symbol] ′ if V^{†}=H+C₀, where C₀ is a constant. The subspace [symbol] as the coding subspace.

The off-diagonal block R represents the action of H′ between the coding subspace [symbol] and its orthogonal complement [symbol] ^{⊥}. If R=R^{†}=0, the simulator Hamiltonian H′ is block diagonal and e^{-iH′t}=e^{-iB}^{₀}^{t}⊕e^{-iB}^{₁}^{t}. In this case, if V embeds H into H′ (i.e., B₀=H), quantum dynamics e^{-iHt} can be directly simulated by emulating the quantum simulator: given an initial state |ψ0 [symbol] ∈ [symbol] and run quantum simulation, results in the desired state e^{-iHt} |ψ0 [symbol] .

However, when R is non-zero, it will influence the quantum dynamics in a non-trivial way because e^{-iH′t}≠e^{-iB}^{₀}^{t}⊕e^{-iB}^{₁}^{t}. Even if an initial state=|ψ0 [symbol] ∈ [symbol] , it will leak to the non-coding subspace [symbol] ^{⊥} in the quantum evolution. To prevent the unwanted leakage, a “high-energy” penalty for the subspace [symbol] ^{⊥} may be introduced so that the quantum state is forced to stay in the low-energy subspace [symbol] .

Analog simulation with Hamiltonian embedding: Suppose V: [symbol] → [symbol] be an embedding of the target Hamiltonian H into the simulator Hamiltonian H′. Let σ_{R} denote the largest singular value of R, and G>0 is the gap between the spectrum of H=B₀ and B₁, i.e., G=λₘᵢₙ(B₁)−λₘₐₓ(H).

Assume that

$$\frac{{σ}_{R}}{G} \leq \frac{1}{16 ( 1 + \frac{D}{π G} )} ,$$

where D is the width of the spectrum of H:D=λₘₐₓ(H)−λₘᵢₙ(H). Then, for a fixed evolution time t≥0,

$$‖ {V}^{†} {e}^{- {iH}^{′} t} V - {e}^{- i H t} ‖ \leq ( \frac{8 {σ}_{R}^{3}}{{G}^{2}} + \frac{4 \sqrt{2} {σ}_{R}^{2}}{G} ) t .$$

Neutral-atom analog quantum computers solve computational problems by emulating the dynamics of a group of atoms. These atoms are placed individually and deterministically on a two-dimensional plane by optical tweezers. A qubit is realized by an atom with an internal ground state |0 [symbol] and an excited Rydberg state |1 [symbol] . The Rydberg atoms are long-lived and can be coherently controlled by external laser pulses. The evolution of the neutral atoms is described by the Schrödinger equation:

$$i ℏ \frac{d}{dt} \vert ψ ( t ) 〉 = \hat{H} ( t ) \vert ψ ( t ) 〉 ,$$

where the system Hamiltonian reads:

$$\frac{\hat{H} ( t )}{ℏ} = {\sum }_{j} ( \frac{{Ω}_{j} ( t )}{2} {\hat{X}}_{j} - {Δ}_{j} ( t ) {\hat{n}}_{j} ) + {\sum }_{j < k} \frac{{C}_{6}}{{\vert {r}_{j} - {r}_{k} \vert}^{6}} {\hat{n}}_{j} {\hat{n}}_{k} .$$

In the Hamiltonian

$${\hat{X}}_{j} = [ \begin{matrix}0 , 1 \\ 1 , 0\end{matrix} ] and {\hat{n}}_{j} = [ \begin{matrix}0 , 0 \\ 0 , 1\end{matrix} ]$$

are the Pauli-X operator and the number operator acting on the j-th qubit, respectively. Ωⱼ(t), Δⱼ(t) denotes the Rabi frequency and local detuning of the driving laser field on qubit j. C₆ is the Rydberg interaction constant that depends on the particular Rydberg atom used. rⱼ denotes the position vector of the j-th qubit. In each simulation, no more than 256 atoms can be initiated, and the Rydberg interaction constant is C₆=862690×2πMHz·μm⁶.

Given an unweighted graph G=( [symbol] ,ε), where [symbol] denotes the set of vertices and ε denotes the set of edges, adjacency matrix A=(A_{j,k}) for j, k∈ [symbol] and

$${A}_{j , k} = \{ \begin{matrix}1 & ( ( j , k ) ∈ ε ) \\ 0 & ( otherwise )\end{matrix} ,$$

which describes the connectivity of the graph G. The graph Laplacian of the graph G is defined by: L=A−D, where A is the adjacency matrix of G, and D is a diagonal matrix such that D is the degree of the vertex j∈ [symbol] .

The continuous-time quantum walk on the graph G is described by the Schrödinger equation:

$$i \frac{d}{dt} \vert ψ ( t ) 〉 = L \vert ψ ( t ) 〉 ,$$

subject to an initial state |ψ(0) [symbol] =|ψ0 [symbol] ∈C|V|, where | [symbol] | denotes the number of vertices on the graph G.

Quantum walk may be performed on, for example, a lattice graph and/or a periodic lattice graph. For example, for a regular lattice graph: Fix an integer N≥1, the d-dimensional regular lattice graph with N vertices on each edge has N^{d} vertices:

[symbol]

={v=(v₁,v₂, . . . ,v_{d}):vⱼ=0,1, . . . ,N−1},

On the regular lattice graph, two vertices are connected if and only if their coordinates differ by 1 at a single site. In other words, there is an edge connecting the vertices v=(v₁, v₂, . . . , v_{d}) and u=(u₁, u₂, . . . , u_{d}) if there exists an index k∈{1, . . . , d} such that |vₖ−uₖ|=1 and vⱼ=uⱼ for all j≠k.

It is worth noting that regular lattice graphs are actually not regular graphs because the local degrees of vertices are not the same: the degree of “endpoints” on the graph is lower than that of interior points. They are named regular lattice graphs to avoid confusion with the periodic lattice graph in the following definition.

For example, for a periodic lattice graph: Fix an integer N≥1, the d-dimensional periodic lattice graph with N vertices on each edge has N^{d} vertices:

[symbol]

={v=(v₁, . . . , v_{d}):vⱼ∈ [symbol] _{N}}.
and there is an edge connecting the vertices v=(v₁, . . . , v_{d}) and u=(u₁, . . . , u_{d}) if there exists and index k∈{1, . . . , d} such that vₖ−uₖ±1 and vⱼ=uⱼ for all j≠k. The periodic lattice graphs can be regarded as “regular lattice graphs with periodic boundary conditions.” Because of the periodic boundary, these graphs are regular with all vertices of local degree 2d.

The transverse-field Ising model is defined on a n-node chain as:

H=−J(Σⱼ₌₁ⁿ⁻¹\hat{Z}ⱼ\hat{Z}ⱼ₊₁+gΣⱼ₌₁ⁿ\hat{X}ⱼ).

When the coefficient |g|<<1, the system |g|<<1 is in the ordered phase, and it has a two-fold degenerate ground-energy subspace. When J>0, the phase exhibits ferromagnetic ordering; when J<0, the phase exhibits antiferromagnetic ordering.

The antiferromagnetic ordering of the Ising model can be realized on the neutral-atom analog quantum computer: the Rydberg interaction C₆/|rⱼ−rₖ|⁶

$$\frac{\hat{H} ( t )}{ℏ} = {\sum }_{j} ( \frac{{Ω}_{j} ( t )}{2} {\hat{X}}_{j} - {Δ}_{j} ( t ) {\hat{n}}_{j} ) + {\sum }_{j < k} \frac{{C}_{6}}{{\vert {r}_{j} - {r}_{k} \vert}^{6}} {\hat{n}}_{j} {\hat{n}}_{k}$$

must be a positive number.

A simple case of the quantum Ising model by choosing n=3 can be studied. The energy spectrum of the Ising Hamiltonian is plot with J=−1 and g→0: H₀=Z₁Z₂+Z₂Z₃. This system has two ground states:

|g1 [symbol] =|010 [symbol] ,|g2 [symbol] =|101

[symbol]

The ground states have alternating spin-ups (1) and spin-downs (0) so the interaction energy −JΣⱼ₌₁²\hat{Z}ⱼ\hat{Z}ⱼ₊₁ is minimized. Moreover, the first-excited subspace is four-fold degenerate, and there are two high-energy states. If two local detuning terms are added to the Hamiltonian H₀ and H₁=H₀+(\hat{Z}₁ −\hat{Z}₃), the first excited energy subspace is split into two groups: |110 [symbol] and |100 [symbol] go to the ground-energy subspace, while |001 [symbol] and |011 [symbol] go to the high-energy subspace. The ground-energy subspace of H₁ is denoted as [symbol] .

Recall that P [symbol] is the projection onto the subspace [symbol] .

S_{X}=Σⱼ₌₁³\hat{X}ⱼ.

[symbol] S_{X}P_{S} is exactly the adjacency matrix of the 4-node chain graph. To see this, just note that S_{X} can be interpreted as the adjacency matrix of the three-dimensional hypercube, and [symbol] S_{X}P_{S} is the adjacency matrix of the subgraph composed of the four vertices 010,110,101,100. This subgraph is just the 4-node chain graph. S may be specified as the encoding subspace and simulate the quantum walk on the chain graph by emulating the quantum Ising Hamiltonian.

The disclosed quantum walk may be used wherever a random walk is used. For example, the disclosed quantum walk may be used to speed up a Markov chain Monte Carlo. The disclosed quantum walk may be used to speed up unstructured database searches.

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For example, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different example aspects provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for quantum optimization, the system comprising:
a quantum computing system;
a processor; and
a memory, including instructions stored thereon, which, when executed by the processor, cause the quantum computing system to:
access a non-convex problem with an objective function ƒ;
solve the non-convex problem using quantum Hamiltonian descent (QHD); and
display results of the solved non-convex problem.

2. The system of claim 1, wherein solving the non-convex problem includes using the QHD to determine at least one of a global minimum or maximum of the non-convex problem.

3. The system of claim 1, wherein solving the non-convex problem includes using three consecutive phases including a kinetic phase, a global search phase, and a descent phase.

4. The system of claim 3, wherein the QHD includes time-dependent parameters configured to enable convergence to a global minimum, regardless of a shape of ƒ.

5. The system of claim 4, wherein a quantum state of the quantum computing system in QHD remains in a low-energy subspace in a quantum evolution, and a low-energy subspace settles at the global minimizer of ƒ.

6. The system of claim 3, wherein in the kinetic phase, a wave function is characterized by a mobility of wave functions as a result of a dominating kinetic energy term.

7. The system of claim 3, wherein in the global search phase, kinetic energy in the system starts to drain out, wherein a wave function shows a selectivity toward the global minimum of ƒ, and wherein in a probability spectrum a high-energy cluster in the wave function is driven toward a low-energy subspace.

8. The system of claim 7, wherein the quantum computing system is configured to locate a global minimum of ƒ after screening of an entire search domain in the kinetic phase.

9. The system of claim 7, wherein in the descent phase, the wave function settles and becomes concentrated near a global minimizer of ƒ, and wherein the wave function remains in a low-energy subspace.

10. The system of claim 9, wherein a quantum evolution of the quantum computing system converges to a global minimizer x*.

11. The system of claim 1, wherein solving the non-convex problem using the QHD includes:
embedding a Hamiltonian equation of the non-convex problem in the quantum computing system by:
discretizing the Hamiltonian equation to a finite-dimensional matrix;
identifying an invariant subspace of a simulator Hamiltonian for an evolution;
programming the simulator Hamiltonian, where a restriction to the invariant subspace matches the discretized Hamiltonian;
evolving the simulator Hamiltonian for a period of time for the evolution to pass through a kinetic phase and a global search phase, and into a descent phase; and
measuring the invariant subspace to generate solutions to an optimization problem based on the simulator Hamiltonian.

12. The system of claim 1, wherein a convergence to a global optimum is established in both a convex and a non-convex setting.

13. The system of claim 1, wherein the QHD includes a continuous-time Hamiltonian evolution.

14. The system of claim 1, further comprising a quantum simulator including a Quantum Ising Machine.

15. The system of claim 14, wherein the Quantum Ising Machine includes an n-quibit quantum register.

16. A computer-implemented method for quantum optimization, the method comprising:
accessing a non-convex problem with an objective function ƒ;
solving the non-convex problem using quantum Hamiltonian descent (QHD) by:
determining at least one of a global minimum or maximum of the non-convex problem; and
displaying results of the solved non-convex problem.

17. The computer-implemented method of claim 16, wherein solving the non-convex problem includes using three consecutive phases including a kinetic phase, a global search phase, and a descent phase.

18. The computer-implemented method of claim 16, wherein the QHD includes time-dependent parameters configured to enable convergence to a global minimum, regardless of a shape off.

19. The computer-implemented method of claim 16, wherein the method further includes embedding the QHD Hamiltonian in an analog quantum simulator.

20. A non-transitory computer-readable storage medium storing a program for causing a processor to execute a method for quantum optimization, the method comprising:
accessing a non-convex problem with an objective function ƒ;
solving the non-convex problem using quantum Hamiltonian descent by:
determining at least one of a global minimum or maximum of the non-convex problem; and
displaying results of the solved non-convex problem.
